(19) United States
(12) Patent Application Publication
(10) Pub. No.: US 2006/0221444 A1
(43) Pub. Date: Oct. 5, 2006

(54) Image displaying apparatus

(75) Inventors: Kei Fukaishi, Niigata (JP); Yoshihiro Yoshihara, Niigata (JP); Hiroshi Maruyama, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co. Ltd., Niigata (JP)

(21) Appl. No.: 11/395,761

(22) Filed: Mar. 31, 2006

(30) Foreign Application Priority Data
Mar. 31, 2005 (JP) 2005-104104

(51) Int. Cl. G02B 27/24

(52) U.S. Cl. 359/472; 359/462

(57) ABSTRACT

An image displaying apparatus is provided, which can display a 2D image can be displayed with wide viewing angle and high definition, without including a fast response LCD or without switching a light source at high speed. The image displaying apparatus which projects parallax images on a viewer includes; a light source unit which emits light to the viewer; an imaging section which forms the images; optical means which directs the light emitted from the light source unit to the imaging section; and a switching diffuser which switches between the transparent state in which the light directed to the viewer is transmitted and the translucent state in which the light is diffused.

### CROSS REFERENCE TO RELATED APPLICATION

The present application claims priority from a Japanese Patent Application No. JP 2005-104104 filed on Mar. 31, 2005, the contents of which are incorporated herein by reference.

### BACKGROUND OF THE INVENTION

1. Field of the Invention

The present invention relates to an image displaying apparatus. Especially, the present invention relates to an image displaying apparatus which projects parallax images onto the left and right eyes respectively to display a three-dimensional image.

2. Related Art

A conventional art, for example Japanese Patent Application Publication No. 2004-264338, discloses three-dimensional image displaying apparatus which can display a two-dimensional (2D) image without parallax as well as a three-dimensional (3D) image with parallax.

The image displaying apparatus disclosed in Japanese Patent Application Publication No. 2004-264338 employs an auxiliary light source which is set behind a pair of main light sources used for displaying a three-dimensional image so that the display device can display the two-dimensional image with a wider viewing angle.

There is a problem, however, in the conventional art disclosed in Japanese Patent Application Publication No. 2004-264338 that when the auxiliary light source is used, the light emitting therefrom is disturbed by the main light source so that the two-dimensional image cannot be displayed with even brightness.

There is another system than the prior art disclosed in Japanese Patent Application Publication No. 2004-264338 that a pair of main light sources is turned on alternately so that the two-dimensional images for the left and right eyes respectively are displayed alternately at high speed. In this system, the images for left and right eyes are displayed alternately at high speed so that a viewer sees a two-dimensional image due to the afterimage. Such system, however, needs to turn the pair of main light sources on and off at high speed and a liquid crystal display (LCD) panel needs to switch completely. A pair of two-dimensional images is displayed alternately at high speed, which causes flickers.

### SUMMARY OF THE INVENTION

To solve the problems, according to the first embodiment of the present invention, an image displaying apparatus which projects images on a viewer includes; a light source unit which projects light on the viewer; an imaging section which forms an image; an optical means which exit the light emitted from the light source unit toward the imaging section; and a switching diffuser which can switch between a transparent state in which the light is transmitted therethrough directly toward the viewers and a translucent state in which the light is diffused and scattered to be transmitted.

In the above image displaying apparatus, the light source unit may consist of a lighting component for left-eye which projects light on the left eye of the viewer, and a lighting component for right-eye which projects light on the right eye of the viewer. The imaging section may include two states; the parallax images forming state in which the left eye image is formed in the left-eye image forming regions and the right eye image in the right-eye image forming regions, and the nonparallax images forming state in which the nonparallax or two-dimensional images are formed in both the left-eye image forming regions and the right-eye image forming regions. The optical means may direct the light emitted from the left-eye lighting component to the left-eye image forming regions in the imaging section and direct the light emitted from the right-eye lighting component to the right-eye image forming regions in the imaging sections.

The above image displaying apparatus may include a switching diffuser controller which controls the switching diffuser to make it transparent when a 3D image is displayed and to make it translucent when a 2D image is displayed.

The above image displaying apparatus may further include a light source unit controller which controls the left-eye and right-eye lighting components to emit light with higher brightness when a 2D image is displayed than when a 3D image is displayed.

The above image displaying apparatus may further include a unidirectional diffuser which spreads and diffuses the light from the left-eye and right-eye images forming regions only in vertical direction.

In the above image displaying apparatus, the switching diffuser may be assembled closer to the viewer than the unidirectional diffuser. The switching diffuser may also be assembled between the imaging section and the unidirectional diffuser.

In the above image displaying apparatus, the optical means may include a light source unit polarizer which polarizes the lights emitted from the left-eye lighting component and the right-eye lighting component to have the polarization axes perpendicular to each other; a condenser lens which focuses the light emitted from the left-eye lighting component and polarized by the light source unit polarizer on the left eye of the viewer; and focuses the light emitted from the right-eye lighting component and polarized by the light source unit polarizer on the right eye of the viewer, and a micropatterned retarder which modifies the polarizations of the lights exiting from the condenser lens and entering the left-eye image forming regions and the right-eye image forming regions respectively to have the polarization axes perpendicular to each other. The switching diffuser may be assembled between the light source unit polarizer and the condenser lens.

The above description of the present invention doesn't cite all the features of the present invention. The sub-combinations of these features may also be inventions.

Apparently from the above description, according to the first embodiment of the present invention, an image displaying apparatus can be provided, which can display not only a 3D image with small cross-talk and without using a fast response LCD or switching a light source at high speed, and also a 2D image with wide viewing angle and high definition.

### BRIEF DESCRIPTION OF THE DRAWINGS

FIG. 1 is an exploded perspective view of the image displaying apparatus related to the embodiment of the present invention.

FIG. 2 is a schematic plane view of the image displaying apparatus 100.

FIG. 3 is a schematic view showing the switching diffuser 200 in the transparent state.

FIG. 4 is a schematic view showing the switching diffuser 200 in the translucent state.

FIG. 5 is a schematic plane view showing how the image displaying apparatus 100 displays the 2D images.

FIG. 6 is a schematic plane view of another example of where to assemble the switching diffuser 200 in the image displaying apparatus.

FIG. 7 is also a schematic plane view of another example of where to assemble the switching diffuser 200 in the image displaying apparatus.

### DETAILED DESCRIPTION OF THE INVENTION

The following description explains the present invention with embodiments. The embodiments described below do not limit the invention claimed herein. All of the combinations described on the embodiments are not essential to the solutions of the present invention.

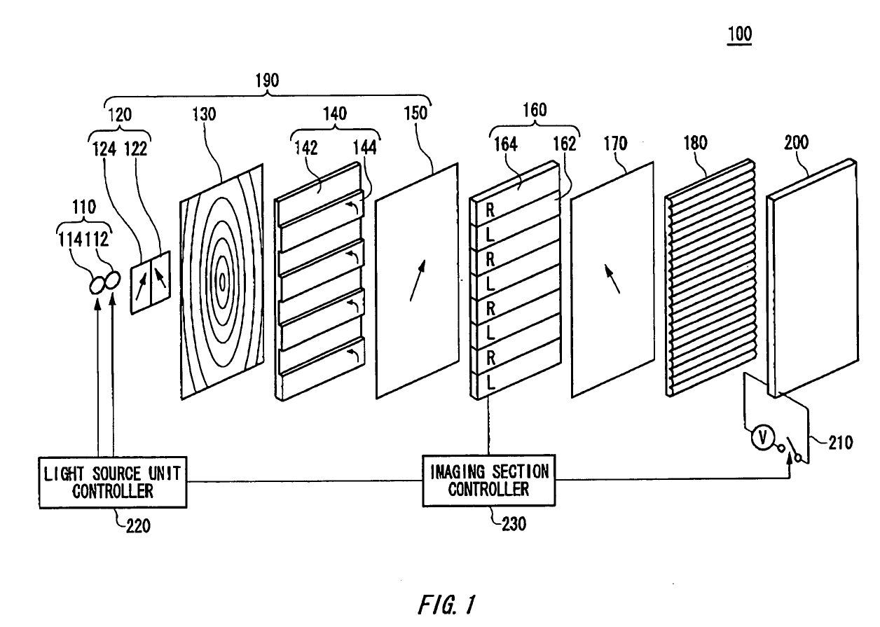

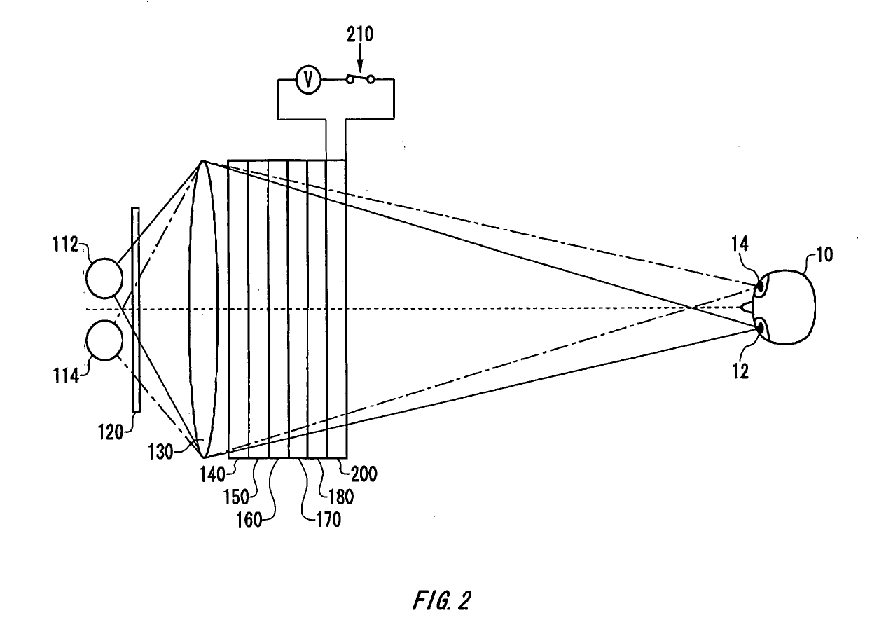

FIG. 1 is an exploded perspective view of the image displaying apparatus 100 related to the present invention. FIG. 2 is a schematic plan view of the image displaying apparatus 100. The image displaying apparatus 100 displays a 3D image by projecting parallax images on the left eye 12 and the right eye 14 of a viewer 10 respectively, and displays a nonparallax image, or 2D image.

As shown in FIG. 1, the image displaying apparatus 100 comprises a light source unit 110, an optical means 190, an imaging section 160, a liquid crystal polarizer 170, a unidirectional diffuser 180, and a switching diffuser 200, each of which is assembled in this order toward a viewer 10. The image displaying apparatus 100 further comprises a light source unit controller 220 which controls the light source unit 110, an imaging section controller 230 which controls the imaging section 160, and a diffuser controller 210 which controls the switching diffuser 200. The imaging section 160 has left-eye image forming regions 162, in which an image for left eye is formed and right-eye image forming regions 164, in which an image for right eye is formed, both of which are described below.

As shown in FIGS. 1 and 2, the light source unit 110 has a pair of lighting components for left eye and right eye 112 and 114 respectively. The left eye lighting component 112 is set in the right side of the optical center of the image displaying apparatus 100 as seen by the viewer 10, and emits light to the left eye 12 of the viewer 10. The right eye lighting component 114 is set in the left side of the optical center of the image displaying apparatus 100 as seen by the viewer 10, and emits light to the right eye 12 of the viewer 10.

The lights emitted from the left eye lighting component 112 and right eye lighting component 114 have no polarizations.

The light emitted from the left eye lighting component 112 passes through the optical means 190 and enters the left eye image forming regions 162 of the imaging section 160. The light emitted from the right eye lighting component 114 passes through the optical means 190 and enters the right eye image forming regions 164 of the imaging section 160. In the system shown in FIG. 1, the optical means 190 includes the light source unit polarizer 120, the condenser lens 130, the micropatterned retarder 140, and the liquid crystal polarizer 150, each of which is assembled in this order from the light source 110 to the imaging section 160.

The lights emitted from the left eye lighting component 112 and the right eye lighting component 114 pass through the light source unit polarizer 120 so that the lights have the polarization axes perpendicular to each other. In the system shown in the FIG. 1, the light source unit polarizer 120 has a polarizer for left eye 122 in which the light emitted from the left eye lighting component 112 and a polarizer for right eye 124 in which the light emitted from the right eye lighting component 114. The unpolarized light emitted from the left eye lighting component 112 passes through the polarizer for left eye 122 to be filtered so that the light having a certain oscillating direction of electric field, for example, at −45 degrees exits to be a linearly polarized light. The unpolarized light emitted from the right eye lighting component 114 passes through the polarizer for right eye 124 to be filtered so that the light having the polarization direction which is perpendicular to that of the polarizer for left eye 122, in the above case the oscillating direction of electric field of +45 degrees exits to be a linearly polarized light.

The light emitted from the light source unit 110 is focused by the condenser lens 130. In the system shown in FIG. 1, the condenser lens 130 is a Fresnel lens sheet. As shown in FIG. 2, the light emitted from the left eye lighting component 112 and polarized by the polarizer for left eye 122 is focused by the condenser lens 130 on the left eye 12 of the viewer 10. The light emitted from the right eye lighting component 114 and polarized by the polarizer for right eye 124 is focused by the condenser lens 130 on the right eye 14 of the viewer 10.

The lights which are emitted from the light source unit 110, exit through the condenser lens 130 and have certain polarization axes pass through the micropatterned retarder 140 so that the lights have the polarization axes perpendicular to each other. In the system shown in FIG. 1, the micropatterned retarder 140 consists of the non-retarding regions 142 and the retarding regions 144, each of which is horizontally extended strip and is alternately arranged in vertical direction. The light incident on the non-retarding regions 142 maintains the original polarization. The light incident on the retarding regions 144 is rotated the polarization axis by 90 degrees. An example of the retarding region 144 is a half wave retarder. The half wave retarder may be replaced by a liquid crystal panel.

The liquid crystal polarizer 150 has a unique, single polarization direction. The light having the polarization direction which is parallel to the polarization direction of the liquid crystal polarizer 150 passes therethrough, but the light having the polarization direction which is perpendicular to the same is cut off. The liquid crystal polarizer 150 is set closer to the light source unit 110 than the imaging section 160. The liquid crystal polarizer 170 has a uniquely oriented polarization axis which is perpendicular to the polarization axis of the liquid crystal polarizer 150. The light having the polarization axis which is parallel to the polarization axis of the liquid crystal polarizer 170 passes, but the light having the polarization axis which is perpendicular thereto is cut off. The liquid crystal polarizer 170 is set closer to the viewer 10 than the imaging section 160. In the system shown in FIG. 1, the liquid crystal polarizer 150 has a polarization axis of +45 degrees, and the liquid crystal polarizer 170 has a polarization axis of −45 degrees.

The imaging section 160 includes the left eye image forming regions 162 which form one of the parallax images for left eye and the right eye image forming regions 164 which form the other of the parallax images for right eye. The imaging section 160 includes a plurality of pixels arrayed in plane horizontally and vertically.

In the system shown in FIG. 1, the imaging section 160 comprises the left eye image forming regions 162 and the right eye image forming regions 164, each of which is horizontally extended strip and alternately arranged in vertical direction. The positions and sizes of the left eye image forming regions 162 and right eye image forming regions 164 correspond to the positions and sizes of the retarding regions 144 and non-retarding regions 142 of the polarizing axis controller 140. The imaging section controller 230 changes the imaging section 160 with such composition between the parallax images forming state and the nonparallax or 2D images forming state. In the parallax images forming state, the parallax images for the left and right eyes respectively are formed on the imaging section 160. In the nonparallax images forming state, the 2D images without parallax are formed on the imaging section 160.

The unidirectional diffuser 180 diffuses and spreads the light exiting from the imaging section 160 only in vertical direction. An example of the unidirectional diffuser 180 is a lenticular lens sheet which includes semi-cylindrical lenses horizontally elongated and arrayed in vertical direction.

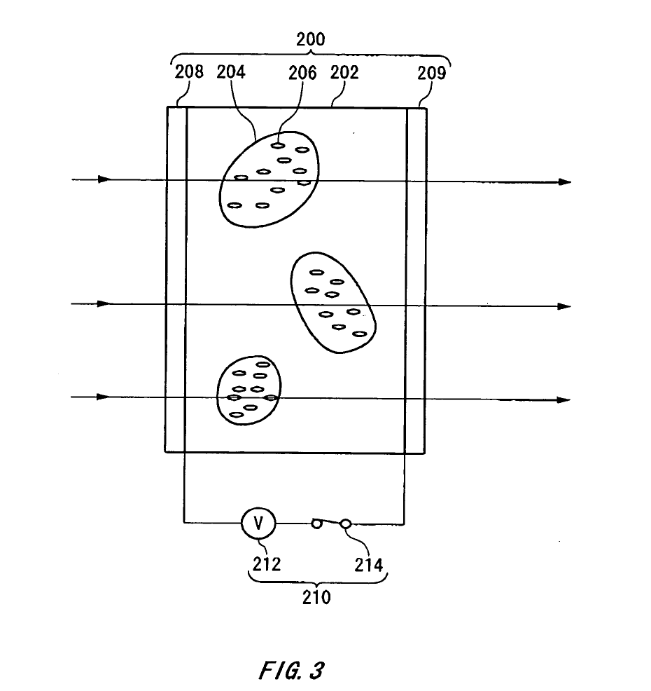

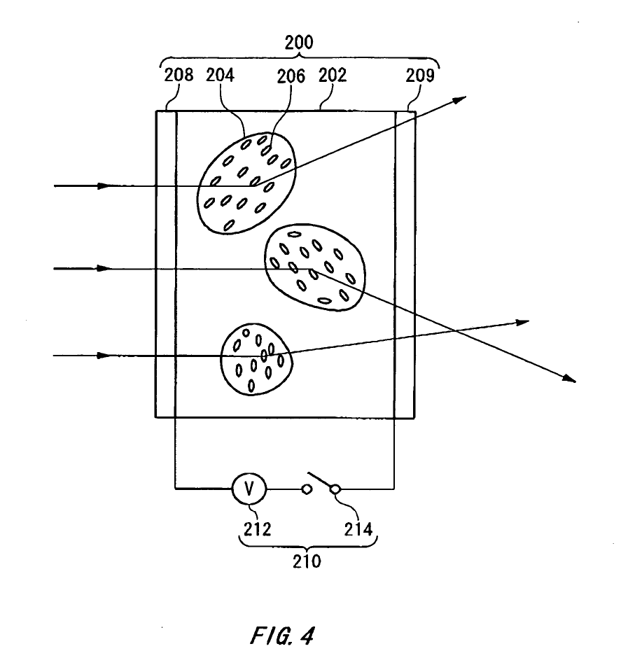

The switching diffuser 200 can be both in the transparent state in which the incident light passes therethrough directly, and in the translucent state in which the incident light is diffused and scattered to be transmitted. An example of the switching diffuser 200 is a diffuser using polymer-dispersed liquid crystal, which is shown in FIGS. 3 and 4. The diffuser controller 210 switches the state of the switching diffuser 200 between the transparent state and the translucent state.

FIG. 3 is a schematic view of the switching diffuser 200 in the transparent state. FIG. 4 is a schematic view of the switching diffuser 200 in the translucent state.

In the switching diffuser 200 shown in FIG. 3, liquid crystal droplets 204 including liquid crystal molecules 206 disperse in a polymer matrix 202, which is sealed and sandwiched between transparent electrodes 209. It is preferred that the refractive indexes of the liquid crystal droplets 204 and the polymer matrix 202 are approximately the same. The diffuser controller 210 which controls the switching diffuser 200 includes a voltage circuit 212 which applies a voltage to polymer-dispersed liquid crystal sandwiched by the transparent electrodes 208 and 209, and a switch 214 which turns on or off to apply a voltage to the voltage circuit 212 or not.

As shown in FIG. 3, when the switch 214 is on the liquid crystal molecules 206 contained in the liquid crystal droplets 204 are oriented against the transparent electrodes 208 and 209. In this stage, the incident light through the transparent electrode 208 goes straight with almost no disturbance from the liquid crystal molecules 206 and exits from the transparent electrode 209. When the switching diffuser 200 is applied a voltage, therefore, the switching diffuser 200 is appeared to be transparent. In this case, the incident light maintains the original polarization and passes through the switching diffuser 200.

See FIG. 4. When the switch 214 is off, the liquid crystal molecule 206 contained in liquid crystal droplets 204 are randomly oriented.

In such case, the incident light through the transparent electrode 208 is bent by the randomly oriented liquid crystal molecules 206. When the switching diffuser 200 isn't applied a voltage, the switching diffuser 200 diffuses and scatters the light in all directions.

How to display and show a 3D image to the viewer 10 with the image displaying apparatus 100 in the above composition is described with the system shown in the FIG. 1. The imaging section controller 230 is input the instruction of displaying a 3D image and outputs the instruction of turning the left eye lighting component 112 and the right eye lighting component 114 on to the light source unit controller 220. The imaging section controller 230 then operates to form the parallax image for the left eye on the left eye image forming regions 162 and the parallax image for the right eye on the right eye image forming regions 164. The imaging section controller 230 outputs the instruction of bringing the switching diffuser 200 in the transparent state to the diffuser controller 210. Under the instruction, the diffuser controller 210 turns the switching diffuser 200 into the transparent state.

Under the instruction of the imaging section controller 230, the light source unit controller 220 turns on both the left eye lighting component 112 and the right eye lighting component 114. The unpolarized light emitted from the left eye lighting component 112 is filtered by the polarizer for left eye 122 so that the light having the vibration direction of electric field of −45 degrees is transmitted to be the linearly polarized light. The linearly polarized light is focused and transmitted by the condenser lens 130 toward the left eye 12 of the user 10. The linearly polarized light having the −45 degrees polarization axis exits from the condenser lens 130 and enters the micropatterned retarder 140.

The linearly polarized light maintains the original polarization axis of −45 degrees and passes through the non-retarding regions 142. The linearly polarized light having the polarization axis of −45 degrees and transmitted through the non-retarding regions 142 enters the liquid crystal polarizer 150. The liquid crystal polarizer 150 has a polarization axis of +45 degrees, which is perpendicular to the polarization axis of −45 degrees of the linearly polarized light. The light which is emitted from the left eye lighting component 112 and is transmitted through the non-retarding regions 142 is cut off by the liquid crystal polarizer 150. The light emitted from the left eye lighting component 112 cannot reach the right eye image forming regions 164 corresponding to the non-retarding regions 142. The right eye image of the parallax images formed in the right eye image forming regions 164 cannot be projected on the left eye 12 of the viewer 10.

The linearly polarized light having the polarization axis of −45 degrees enters the retarding regions 144 of the micropatterned retarder 140, is rotated the polarization axis by 90 degrees to be +45 degrees, and is transmitted therethrough. The linearly polarized light which emitted from the left eye lighting component 112 and passes through the retarding regions 144 becomes to have the equally oriented polarization axis to the polarization axis of the liquid crystal polarizer 150. The linearly polarized light, therefore, can be transmitted through the liquid crystal polarizer 150.

The light transmitted through the liquid crystal polarizer 150 is transmitted through the left eye image forming regions 162 corresponding to the retarding regions 144 to be rotated the polarization axis by 90 degrees to be turned into −45 degrees. The light projecting the left eye image of the parallax images formed on the left eye image forming regions 162 passes through the liquid crystal polarizer 170 as is, and is diffused and spread vertically by the unidirectional diffuser 180. Under the instruction of the image section controller 230, the diffuser controller 210 operates the switching diffuser 200 to be in the transparent state so that the light vertically diffused by the unidirectional diffuser 180 is transmitted through the switching diffuser 200. The light emitted from the left eye lighting component 112 is focused on the vertical line passing through the left eye 12 of the viewer 10, and the left eye image of the parallax images formed on the left eye forming regions 162 is projected on the left eye 12.

The light emitted from the right eye lighting component 114 is polarized by the polarizer for right eye 124 to have the polarization axis of +45 degrees. The light transmitted through the polarizer for right eye 124 and the non-retarding regions 142 projects the right eye image of parallax images formed on the right eye image forming regions 164 on the right eye 14 of the viewer 10. In contrast, the light transmitted through the polarizer for right eye 124 and the retarding regions 144 is cut off so that the left eye image of parallax images formed on the left eye image forming regions 162 isn't projected to the left eye 12 of the viewer 10.

According to the above description, the image displaying apparatus 100 can project the parallax images to display a 3D image to the viewer 10. In this case, using the unidirectional diffuser 180 allows the 3D image to be displayed with wide vertical viewing angle.

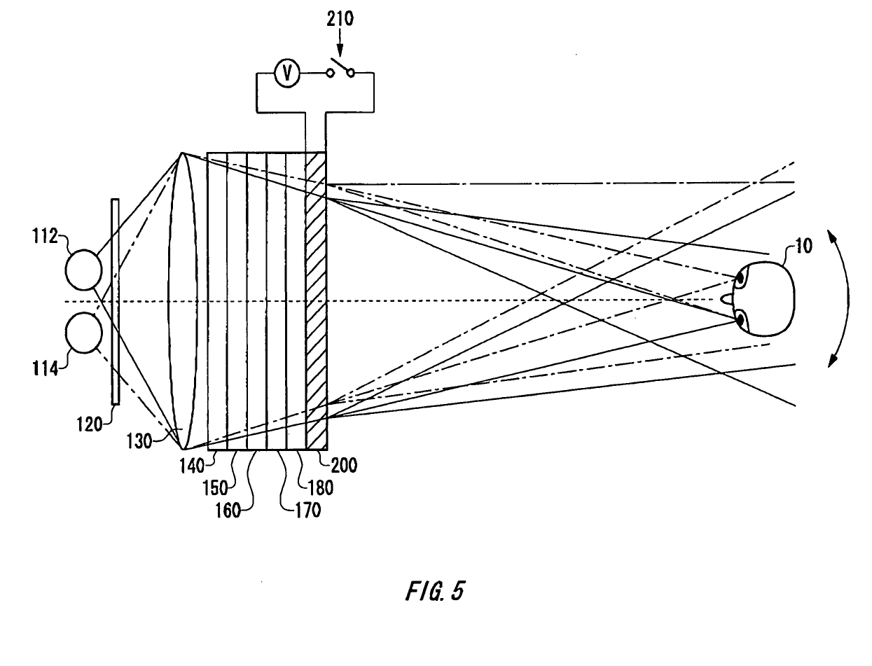

FIG. 5 is schematic plane view showing the image displaying apparatus 100 displaying a 2D image. The following describes how the image displaying apparatus 100 operates to display the 2D image using FIGS. 1 and 5.

When the imaging section controller 230 is input the instruction of displaying 2D images, the imaging section controller 230 outputs the instruction of turning the left eye lighting component 112 and right eye lighting component 114 on to the light source unit controller 220, similarly to displaying a 3D image. The imaging section controller 230 forms the 2D image using both the left eye image forming regions 162 and the right eye image forming regions 164. The image is formed in one piece of liquid crystal panel including both the left eye image forming regions 162 and the right eye image forming regions 164. The imaging section controller 230 also outputs the instruction of turning into the translucent state to the diffuser controller 210. The diffuser controller 210 turns the switching diffuser 200 into the translucent state under the instruction.

Under the instruction of the imaging section controller 230, the light source unit controller 220 turns the left eye lighting component 112 and the right eye lighting component 114 on. In such case, similarly to displaying a 3D image, the light emitted from the left eye lighting component 112 reaches the left eye image forming regions 162, but doesn't reach the right eye image forming regions 164. Similarly, the light emitted from the right eye lighting component 114 reaches the right eye image forming regions 164, but doesn't reach the left eye image forming regions 162.

The light emitted from the left eye lighting component 112 and passing through the left eye image forming regions 162 and the light emitted from the right eye lighting component 114 and passing through the right eye image forming regions 164 pass through the liquid crystal polarizer 170, are diffused and spread by the unidirectional diffuser 180 in vertical direction, and enter the switching diffuser 200. When the switching diffuser 200 is in the translucent state under the instruction of the diffuser controller 210, both the light emitted from the left eye lighting component 112 and passing through the left eye image forming regions 162 and the light emitted from the right eye lighting component 114 and passing through the right eye image forming regions 164 are diffused both vertically and horizontally.

As shown in FIG. 5, the 2D image can be displayed and viewed in horizontally wide space including the viewer 10. In this case, the image displaying apparatus 100 diffuses the lights exiting both from the left eye image forming regions 162 and the right eye image forming regions 164 so that the 2D image with high definition in horizontally wide space including the viewer 10, or in the space indicated by the arrow in FIG. 5.

According to the above embodiment, a 3D image can be displayed with small cross-talk and a 2D image can be displayed with wide viewing angle and high definition without using a high-response liquid crystal panel or switching a light source at high speed.

In both cases which a 3D image or a 2D image is displayed, both the left eye lighting component 112 and the right eye lighting component 114 are turned on.

This prevents blinking or flicker which is felt by the viewer 10 when the left eye lighting component 112 and the right eye lighting component 114 are alternately turned on.

The switching diffuser 200 is set closer to the viewer 10 than the unidirectional diffuser 180 so that the switching diffuser 200 can be used without changing the existing design of the image displaying apparatus.

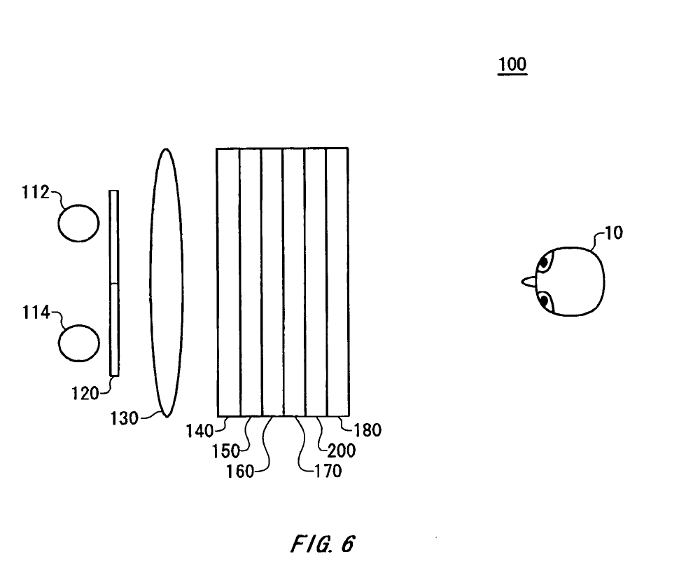

FIG. 6 is a schematic plane view showing where to assemble the switching diffuser 200 in the image displaying apparatus 100.

The same numerical symbols in FIG. 6 as in FIGS. 1-5 have the same meanings.

It is the difference in the image displaying apparatus shown in FIG. 6 from those shown in the FIGS. 1-5 that the switching diffuser 200 is assembled between the liquid crystal polarizer 170 and the unidirectional diffuser 180. Outside light is diffused by the unidirectional diffuser 180 so that little outside light reaches the switching diffuser 200 in such position.

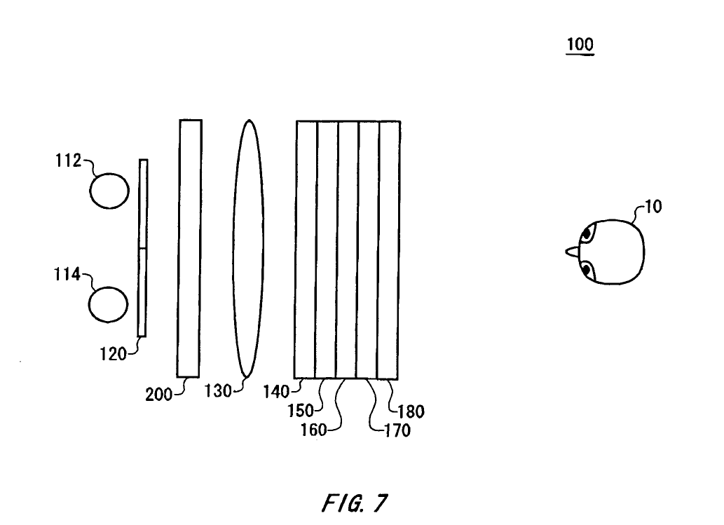

FIG. 7 is a schematic plane view showing another example of where to assemble the switching diffuser 200 in the image displaying apparatus. The same numerical symbols in FIG. 7 as in FIGS. 1-5 have the same meanings.

It is the difference in the image displaying apparatus shown in FIG. 7 from those shown in the FIGS. 1-5 that the switching diffuser 200 is assembled between the light source unit polarizer 120 and the condenser lens 130. Even if the switching diffuser 200 is assembled in such position, the left eye image of parallax images and the right eye image of parallax images can be projected on both the left eye 12 and the right eye 14 of the viewer 10 respectively when the switching diffuser 200 is in the transparent state in which the light can be transmitted therethrough as maintaining the polarization direction.

When the switching diffuser 200 in such position is in the translucent state, the switching diffuser 200 diffuses light in closer position to the light source 110 than the condenser lens 130 so that the 2D image can be displayed at wider viewing angle.

In the above embodiments, the left eye lighting component 112 and the right eye lighting component 114 are put together and arrayed in the left and right sides. There may be one or more pairs of the left eye lighting component 112 and the right eye lighting component 114 The plurality of the left eye lighting components 112 may be arrayed in the right side of the optical center of the image displaying apparatus, and the same number of the right eye lighting components 114 may be arrayed in the left side of the optical center of the image displaying apparatus. This allows the 2D images to be displayed in wider area. In this case, a 3D image may be displayed with turning one pair of the left eye lighting component 112 and the right eye lighting component 114 on, and the 2D image may be displayed with turning the plurality of the left eye lighting component 112 and the right eye lighting component 114 on. This can compensate the lower brightness felt by the viewer due to light diffusion by the switching diffuser 200 and can assure the brightness which is approximately equal to that of displaying 3D images. With another way to compensate the brightness without using the plurality of the left eye lighting components 112 and the right eye lighting components 114, when a 2D image is displayed, a pair of the left eye lighting component 112 and the right eye lighting component 114 emits light with higher brightness than when a 3D image is displayed.

In the above embodiment, the switching diffuser 200 is in the transparent state when it is turned on, and in the translucent state when it is turned off, and vice versa. The switching diffuser 200 may use the liquid crystal which is used for liquid crystal displays as well as polymer dispersed liquid crystal.

In the above embodiments, the image displaying apparatus 100 displays both a 3D image and a 2D image. The image displaying apparatus 100 may, however, be a 2D image displaying apparatus which displays a 2D image. In this case, the switching diffuser 200 can switch between the state in which the 2D image is neither diffused nor spread so that the 2D image cannot seen by others around the viewer and the state in which the 2D image is diffused and spread so that the 2D image can be seen by not only the viewer but also the others around the viewer.

The above description explaining the present invention with the embodiments does not limit the technical scope of the invention to the above description of the embodiments. It is apparent for those in the art that various modifications or improvements can be made to the embodiments described above. It is also apparent from what we claim that other embodiments with such modifications or improvements are included in the technical scope of the present invention.

What is claimed is:

1. An image displaying apparatus projecting an image on a viewer, which includes;
a light source unit which emits light to the viewer;
an imaging section which forms the image;
an optical means which directs the light emitted from said light source unit at said imaging section; and
a switching diffuser which turns into the transparent state in which the light directed to said viewer is transmitted as is and the translucent state in which the light is diffused and scattered to be transmitted.

2. The image displaying apparatus according to claim 1, wherein said light source unit includes one or plurality of left eye lighting components which emit light to the left eye of the viewer and one or plurality of right eye lighting component which emit light to the right eye of said viewer,
wherein said imaging section includes the parallax images forming state in which a left eye image is formed in left eye image forming regions and a right eye image in right eye image forming regions, and the two-dimensional images forming state in which the two-dimensional images are formed in both said left eye image forming regions and said right eye image forming regions,
wherein said optical means directs the light emitted from said left eye lighting component to said left eye image forming regions in said imaging section and directs the light emitted from said right eye lighting component to said right eye image forming regions in said imaging section.

3. The image displaying apparatus according to claim 2, which further includes a switching diffuser controller which controls said switching diffuser to make it transparent when a 3D image is displayed and to make it translucent when a 2D image is displayed.

4. The image displaying apparatus according to claim 3, which further includes a light source unit controller which controls said left eye lighting component and said right eye lighting component to emit light with higher brightness when a 2D image is displayed than when a 3D image is displayed.

5. The image displaying apparatus according to claim 1, which further includes a unidirectional diffuser which spreads and diffuses the light exiting from said left eye image forming regions and said right eye image forming regions in vertical direction.

6. The image displaying apparatus according to claim 5, wherein said switching diffuser is assembled closer to said viewer than said unidirectional diffuser.

7. The image displaying apparatus according to claim 5, wherein said switching diffuser is assembled between said imaging section and said unidirectional diffuser.

8. The image displaying apparatus according to claim 1, wherein the optical means includes;
a light source unit polarizer which polarizes the lights emitted from said left eye lighting component and said right eye lighting component to have the polarization axes perpendicular to each other;
a condenser lens which focuses the light emitted from said left eye lighting component and polarized by said light source unit polarizer on said left eye of said viewer, and focuses the light emitted from said right eye lighting component and polarized by said light source unit polarizer on said right eye of the viewer; and
a micropatterned retarder which modifies the lights exiting from said condenser lens and entering said left eye image forming regions and said right eye image forming regions respectively to have the polarization axes perpendicular to each other,
wherein, said switching diffuser is assembled between said light source unit polarizer and said condenser lens.
